(19) United States
(12) Patent Application Publication
(10) Pub. No.: US 2018/0215321 A1
(43) Pub. Date: Aug. 2, 2018

(54) TRUCK BED ACCESSORIES

(71) Applicant: Motor City Aftermarket, Livonia, MI (US)

(72) Inventors: Adam Allen, Plymouth, MI (US); Justin Allen, Plymouth, MI (US)

(21) Appl. No.: 15/885,056

(22) Filed: Jan. 31, 2018

Related U.S. Application Data
(60) Provisional application No. 62/453,144, filed on Feb. 1, 2017.

(51) Int. Cl. B60R 9/00

(52) U.S. Cl. CPC B60R 9/00; B60R 2011/0059

(57) ABSTRACT

A truck bed adaptor rail including an elongated base plate extending along a longitudinal axis and having an outboard portion and an inboard portion. The base plate of the adaptor rail has an inboard flange extending along the longitudinal axis of the base plate. The inboard flange extends from the inboard portion of the base plate in a direction away from and below the base plate. The rail may include adaptor retainers axially spaced along the inboard flange. A truck bed cargo management assembly may include the rail and an adjustable clamp. A truck bed cargo management apparatus may include a truck bed accessory including a coupling arm to insert into truck bed adapter retainers and a retention member to secure the accessory with respect to the retainers.

### FIELD

This disclosure generally relates to truck bed accessories, for instance cargo management devices. More specifically, but not exclusively, aspects relate to a modular adaptor for a pickup truck bed that allows for different types of cargo to be secured and that need not be permanently affixed to the truck body.

### BACKGROUND

Cargo management devices, sports bars, and other truck bed accessories are often used in cargo areas such as truck beds, trailers, carts, tractor beds, and other utility vehicles to improve the utility of the cargo space. Many of these cargo management devices are temporary accessories, such as bike racks, bed dividers, and cargo containers that may need to be mounted and dismounted often. Sometimes, the accessories may need to be completely removed from the cargo space and other times the accessories may need to be repositioned within the cargo space.

Mounting and dismounting of accessories is often difficult and time consuming, because it often requires disassembling retaining components or making mechanical adjustments to the accessory retaining components.

### DRAWINGS

One or more embodiments of the present disclosure will hereinafter be described in conjunction with the appended drawings, wherein like designations denote like elements, and wherein:

FIG. 1 illustrates a rear perspective view of an illustrative embodiment of a truck bed adaptor assembly;

FIG. 2 illustrates a fragmentary, exploded, front perspective view according to the truck bed adaptor assembly shown in FIG. 1;

FIG. 3 illustrates an enlarged perspective view of a portion of a truck bed divider;

FIG. 4 illustrates a cross-sectional view of a truck bed adaptor rail and two illustrative truck bed cargo management accessories installed in a truck bed;

FIG. 5 illustrates a perspective view of an adjustable clamp according to an illustrative embodiment;

FIG. 6 illustrates another perspective view of the adjustable clamp shown in FIG. 5; and

FIG. 7 illustrates a cross-sectional view of a truck bed adaptor rail and an adjustable clamp as installed in a truck bed.

### DESCRIPTION

In general, an assembly and elements thereof will be described using an illustrative embodiment of a cargo management assembly in a pickup truck bed. However, it will be appreciated as the description proceeds that embodiments of the present disclosure may be used in other cargo areas, for example, trailers, carts, tractor beds, and the like.

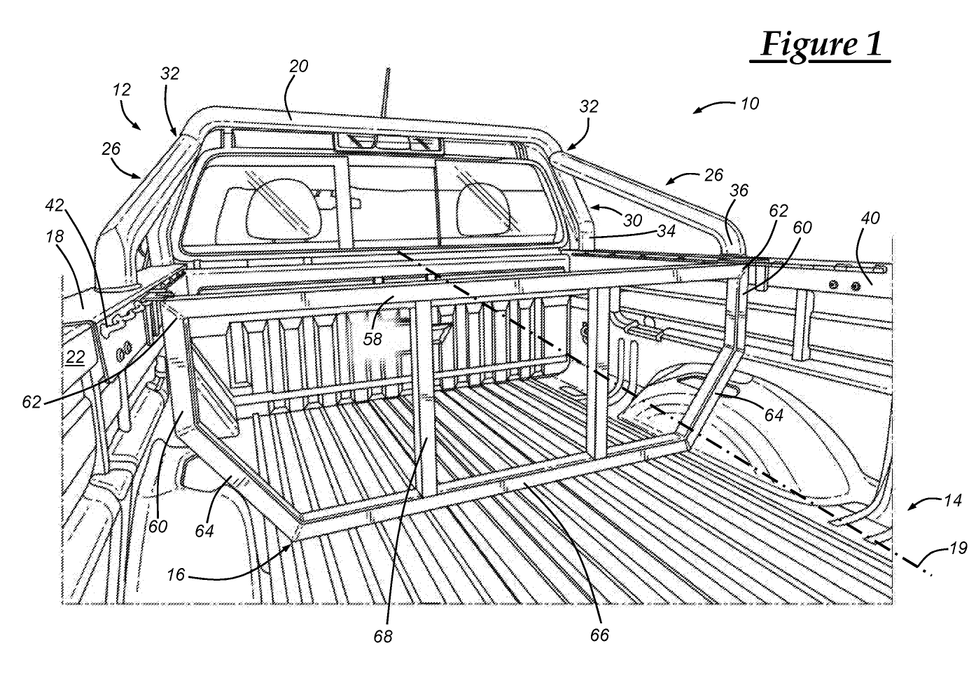

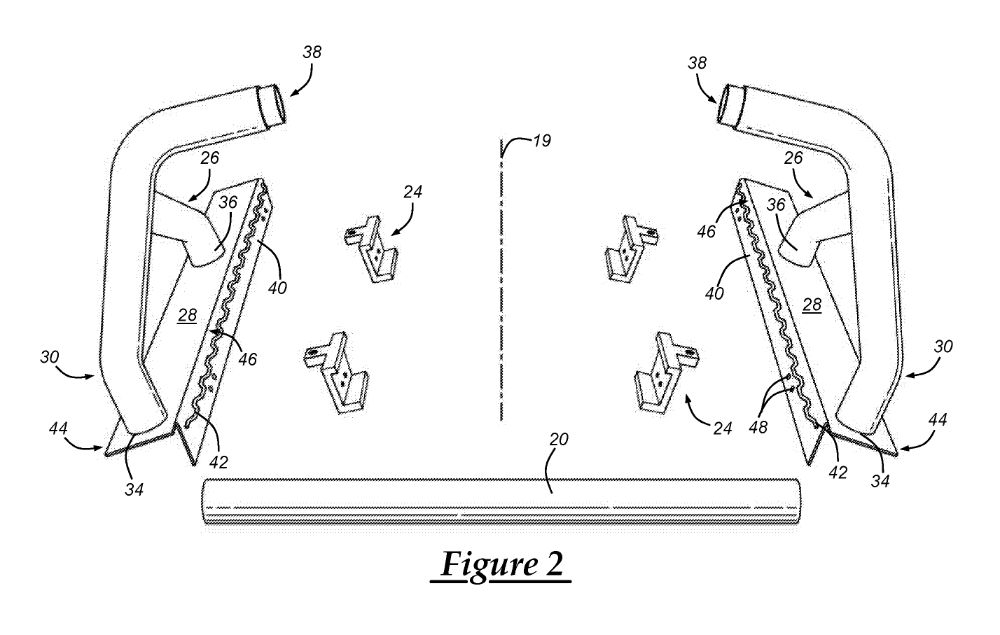

With reference specifically to the drawings, FIGS. 1 and 2 show an illustrative embodiment of a truck bed cargo management assembly 10. The cargo management assembly 10 may include a sport bar assembly 12 carried by a truck bed 14 and a cargo management accessory 16 adjustably carried by the sport bar assembly 12. The sport bar assembly 12 may include a pair of truck bed adaptor rails 18 disposed on either side of a longitudinal axis 19, the cargo management accessory 16 secured between the adaptor rails 18, and a crossbar 20 connecting the adaptor rails 18. As used in this specification and claims, the terms “longitudinal axis,” “axis,” and “axially” refer to a longitudinal axis 19 of a vehicle, or an axis coaxial with respect to a longitudinal axis of a vehicle, unless explicitly defined otherwise herein. The truck bed adaptor rails 18 are configured to be carried on the laterally spaced and longitudinally extended rails 22 of a pickup truck bed 14. More specifically, the truck bed adaptor rails 18 may grip the pickup truck bed rails 22, or they may be secured thereto, for example, via Velcro, glue, or other adhesives, or they may be pinch pressed to the truck bed rails 22, or any other suitable method of attachment. Even more specifically, as will be described below, the truck bed adaptor rails 18 may be secured to the truck bed rails 22 via one or more adjustable clamps 24 shown in FIG. 2.

With continuing reference to FIGS. 1 and 2, the sport bar assembly 12 may include a pair of rearward bars 26, each rearward bar 26 extending upwardly away from an elongated base plate 28 of one of the truck bed adaptor rails 18, and also may include a pair of forward bars 30, each forward bar extending upwardly away from the elongated base plate 28 of one of the truck bed adaptor rails 18 and connected to the corresponding rearward bar 26 at an intermediate attachment section 32 of the forward bar 30. Furthermore, the sport bar assembly 12 may include a crossbar 20 releasably secured between the forward bars 30. The rearward bars 26, forward bars 30, and crossbar 20 may be a rod, shaft, or tube of circular cross-sectional shape, or of any other appropriate cross-sectional shape, and also may be hollow. The rearward bar 26 may be connected to the elongated base plate 28, for example, by welding at a base end 34 of the rearward bar 36 and connected to the intermediate attachment section 32 (FIG. 1) of the forward bar 30. The forward bar 30 may be connected to the elongated base plate 28, for example, by welding at a base end 36 of the forward bar 30 and may include a free end 38 (FIG. 2) configured to couple to the crossbar 20. In the illustrated embodiment, the crossbar 20 is adapted to slidably couple to the forward bars 30 by having an interior cavity marginally greater in diameter than the free end 38 of each forward bar 30, although other suitable coupling methods may be used. For example, the crossbar 20 may slide into the forward bars 30 or fasteners may be used. When the crossbar 20 is thus coupled between the forward bars 30, it may aid in maintaining the desired lateral position of the truck bed adaptor rails 18 with respect to the truck bed rails 22 by resisting any force applied in an inboard direction with respect to one of the adaptor rails 22.

According to one aspect, and with reference to FIG. 2, a truck bed adaptor rail 18 is provided and may include the elongated base plate 28 to locate the adaptor rail 18 on top of the corresponding truck bed rail 22 (FIG. 1), an inboard flange 40 depending away from the base plate 28 to locate the adaptor rail 18 laterally with respect to the bed rail 22, and a plurality of truck bed adaptor retainers 42. The elongated base plate 28 may be elongated in a direction parallel to the longitudinal axis of the vehicle, and may have an outboard portion 44 and an inboard portion 46. The length of the elongated base plate 28 is the predominant dimension because it is greater than the width. The base plate 28 may be flat.

As best seen in FIG. 2, the inboard flange 40 may depend from the inboard portion 46 of the elongated base plate 28. The inboard flange 40 may be of planar configuration and may be substantially perpendicular to the base plate 28, e.g., within ±5°. The angle may be selected, for example, such that, when the assembly is assembled, the elongated base plate 28 sits flush on the truck bed rail 22 and the inboard flange 40 is substantially vertical or normal with respect to the ground. Nevertheless, those skilled in the art will appreciate that other suitable shapes and orientations are possible.

Again with reference to FIGS. 1 and 2, one or more truck bed adaptor retainers 42 may be carried by the inboard flange 40. As shown in the illustrated embodiment, the adaptor retainers 42 may be footman loops axially spaced along the inboard flange 40. The footman loops may be formed as a unitary piece and affixed to the inboard flange 40 via welding, as in the illustrated embodiment, via fastening, or via any other appropriate method. Alternatively, the retainers 42 may be separate loops that are individually affixed to the inboard flange 40. Furthermore, footman loops similar to those in the illustrated embodiment may be integrally formed from the inboard flange 40 itself, for example, by cutting out blanks in the inboard flange 40 and bending remaining portions outward with respect to the inboard flange 40. Those skilled in the art will recognize that the adaptor retainers 42 may take other forms, such as slots or holes in the inboard flange 40, so long as they may be capable of securing a cargo management accessory 16 in a fixed position, as will described in further detail below. The footman loops in the presently disclosed embodiments, however, have the added benefit that they may additionally be used with “tie downs,” another common type of cargo management accessory 16. The plurality of truck bed adaptor retainers 42 may be located vertically on the inboard flange 40 in the area that is generally proximate the base plate 28. According to one aspect, the inboard flange 40 also may include one or more holes 48 configured to receive fasteners 50 to aid in mounting the adaptor rail 18 to the vehicle, as described in detail below. The one or more holes 48 may be located on the inboard flange 40 relatively farther from the elongated base plate 28 than the plurality of adaptor retainers 42 (i.e., when assembled, the holes may be below the adaptor retainers 42).

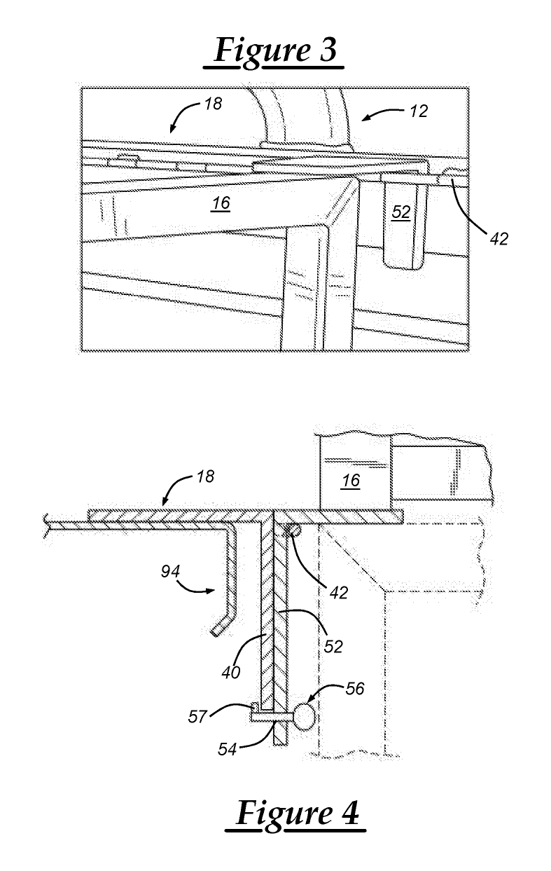

According to one embodiment, an assembly of two of the truck bed adaptor rails 18 described above may be used to releasably secure a cargo management accessory 16. For example, as shown in FIG. 1, the truck bed adaptor rail 18 may be secured to each lateral truck bed rail 22 of a pickup truck such that the plurality of adaptor retainers 42 of each adaptor rail 18 faces the inboard direction and oppose each other—i.e., such that the two truck bed adaptor rails 18 are mirror images of one another. A cargo management accessory 16 may be releasably secured between the opposing adaptor retainers 42. For example, as shown in FIGS. 3 and 4, the cargo management accessory 16 may include a coupling arm 52 depending from the cargo management accessory and capable of being inserted into one of the plurality of adaptor retainers. In addition, the coupling arm 52 may contain a hole 54 for receiving a retention feature 56 to secure the cargo management accessory 16 vertically with respect to the adaptor retainers 42. For example, in the embodiment shown in FIG. 4, the retention feature 56 is a lock pin with a resilient anti-backout feature 57 to prevent the lock pin from becoming accidentally dislodged. The shaft of the lock pin may extend under the inboard flange 40 to resist movement in the vertical direction, and the anti-backout feature 57 may keep the pin in place by contacting the inboard flange 40. However, many other suitable retention devices will be apparent to those skilled in the art. Furthermore, in other embodiments, a cargo management accessory 16 may be secured by one or more of the plurality of adaptor retainers 42 of only a single adaptor rail 18.

With reference to FIG. 1, the broad function of the cargo management accessory 16 is to aid in managing the cargo load of the vehicle, and therefore may take several different forms depending on its intended use. Each possible form or structure, however, may be capable of being releasably secured by at least one of the plurality of adaptor retainers 42, and in this way the assembly is modular. For example, in one embodiment, the cargo management accessory 16 may be a kayak rack, a well-known aftermarket accessory for vehicles. In another embodiment, the cargo management accessory 16 may secure one or more spare tires or wheels. In yet other embodiments, the cargo management accessory 16 may be a ladder rack, or a bed divider as shown in FIG. 1. The bed divider 16 of the illustrated embodiment includes an upper bar 58, two vertical bars 60 descending from the ends 62 of the upper bar 58, two angled bars 64 that connect the vertical bars 60 to a bottom bar 66, and two interior support bars 68 connecting the upper bar 58 and the bottom bar 66. Each of these bars 58, 60, 64, 66, 68 may be a rod, shaft, or tube of rectangular cross-sectional shape, or of any other appropriate cross-sectional shape, and also may be hollow. Additionally, they may be made separately and integrally connected by welding. The bottom bar 66 is shorter than the upper bar 58 so that, for example, the wheel wells of the truck do not obstruct the bed divider. Again, however, skilled artisans will recognize that many other cargo management devices are capable of being used without departing from the scope of the disclosed embodiments.

According to another aspect, the truck bed adaptor assembly 10 is provided which may be attached to the truck bed adaptor rails 18 without screwing into, directly penetrating, or otherwise destructively altering the truck bed adaptor rails 18. With reference generally to FIG. 2, the truck bed adaptor assembly 10 may include the truck bed adaptor rail 18 as described above, with its elongated base plate 28 and inboard flange 40, as well as the adjustable clamp(s) 24.

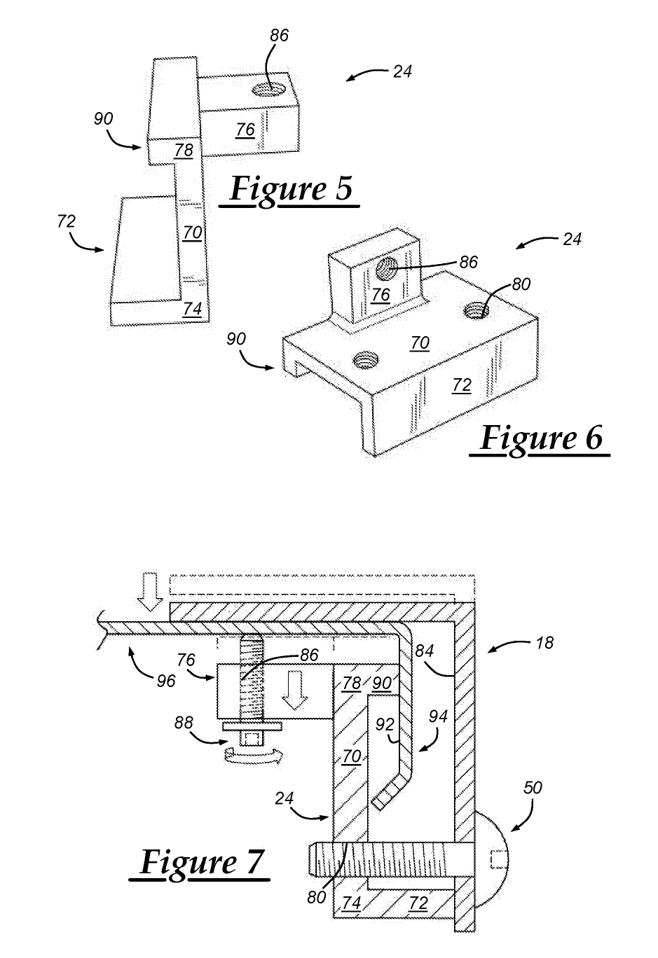

With reference to FIGS. 5 and 6, the adjustable clamp 24 may include a base wall 70 elongated along the longitudinal axis of the vehicle, an adaptor rail locating wall 72 extending from a lower portion 74 of the base wall 70 in an inboard direction to locate the adaptor rail 18 laterally with respect to the adjustable clamp 24, and a clamping portion 76 extending from an upper portion 78 of the base wall 70 in an outboard direction. The base wall 70 also may include at least one hole 80 configured to accept a fastener 50 (FIG. 7). The adaptor rail locating wall 72 extends in an inboard direction away from the lower portion 74 of the base wall 70, and is configured to abut an outboard side 84 of the inboard flange 40 of the truck bed adaptor rail 18. The clamping portion 76 extends in an outboard direction away from the upper portion 78 of the base wall 70 and includes at least one hole 86 for cooperation with a locator 88, for instance, a set screw. The clamping portion 76 may be shorter in axial extent than the base wall 70. In some embodiments, the adjustable clamp 24 also may include a truck bed rail lip locating wall 90 that extends away from the upper portion 78 of the base wall 70 in an inboard direction, and is configured to abut an outboard side 92 of a lip of a truck bed rail 94. The rail lip locating wall 90 therefore may be shorter in the inboard direction than the adaptor rail locating wall 72. In the presently disclosed embodiments, the base wall 70, adaptor rail locating wall 72, and truck bed rail lip locating wall 90 of the adjustable clamp 24 may be fashioned from an aluminum block, and the clamping portion may be attached by, for example, welding. However, skilled artisans will appreciate that other suitable materials and manufacturing methods may be used.

With reference to FIG. 7, it can now be seen that the adjustable clamp 24 may be positioned in such a way as to secure the truck bed adaptor rail 18 in place without the need to penetrate the body of the vehicle (i.e., by screwing the adaptor rail 18 directly into body of the vehicle). The adjustable clamp 24 may be located with respect to the truck bed rail 22 and the truck bed rail lip 94 in such a manner that the at least one hole in the clamp base 80 wall aligns with the corresponding at least one hole 48 in the truck bed adaptor rail 18, allowing the adjustable clamp 24 and the truck bed adaptor rail 18 to be releasably secured together by the fastener 50. A set screw 88 may extend through the hole 86 in the clamping portion 76 of the adjustable clamp 24 for locating against a lower surface 96 of the truck bed rail 22, such that the adjustable clamp 24 may be secured to the truck bed rail 22.

A cargo management assembly 10 has been disclosed that may secure many different types of cargo and which need not be destructively affixed to a vehicle. In general, the components of the assembly herein disclosed may be manufactured according to techniques known to those skilled in the art, including laser cutting, molding, machining, stamping, and the like. Additionally, many of the various components may be fixed to each other via welding, for example, tungsten inert gas (TIG) or metal inert gas (MIG) welding, although the assembly 10 can be assembled according to many known techniques, manual or automatic. Likewise, while the illustrated embodiments are composed of aluminum and steel, any suitable materials can be used in making the components, such as other metals, composites, polymeric materials, and the like.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A truck bed adaptor rail, comprising:
an elongated base plate extending along a longitudinal axis and having an outboard portion and an inboard portion;
an inboard flange extending along the longitudinal axis of the base plate and extending from the inboard portion of the base plate in a direction away from and below the base plate; and
a plurality of truck bed adaptor retainers axially spaced along the inboard flange.

2. The truck bed adaptor rail of claim 1, wherein the plurality of truck bed adaptor retainers are footman loops.

3. A cargo management assembly comprising two of the truck bed adaptor rails as defined in claim 1.

4. The cargo management assembly of claim 3, wherein the truck bed adaptor rails are mirror images of one another and are positioned such that a cargo management accessory is interposable between the truck bed adaptor rails and such that the cargo management accessory is locatable in position by at least one truck bed adaptor retainer on each truck bed adaptor rail.

5. The cargo management assembly of claim 4, wherein the cargo management accessory is a bed divider.

6. The cargo management assembly of claim 4, wherein the cargo management accessory is a kayak rack.

7. The cargo management assembly of claim 4, wherein the cargo management accessory is a ladder rack.

8. The cargo management assembly of claim 4, wherein the cargo management accessory is a tire carrier.

9. The cargo management assembly of claim 3, wherein a crossbar is disposed between the adaptor rails.

10. A sport bar assembly including the assembly of claim 3, wherein each of the truck bed adaptor rails further comprises:
a rearward bar including a base end and an attachment end, the rearward bar extending away from an upper surface of the elongated base plate of the truck bed adaptor rail and connected to the elongated base plate at the base end; and
a forward bar including a base end, a free end, and an intermediate attachment section, the forward bar extending away from an upper surface the elongated base plate, connected to the base plate at the base end, and connected to the attachment end of the rearward bar at the intermediate attachment section.

11. The sport bar assembly of claim 10, wherein a crossbar is disposed between the free ends of each forward bar.

12. A truck bed cargo management assembly, comprising:
a truck bed adaptor rail, comprising:
an elongated base plate extending along a longitudinal axis and having an outboard portion and an inboard portion, and
an inboard flange extending along the longitudinal axis of the base plate and extending from the inboard portion of the base plate in a direction away from and below the base plate; and
an adjustable clamp comprising:
an elongated base wall extending along the longitudinal axis, including an upper portion and a lower portion,
an adaptor rail locating wall extending away from the lower portion of the base wall in an inboard direction to abut the inside surface of the adaptor rail, and
a clamping portion extending in an outboard direction away from the upper portion of the base wall.

13. The cargo management assembly of claim 12, wherein the inboard flange also includes at least one hole configured to receive a fastener and wherein the elongated base wall includes at least one hole corresponding to the ate least one hole in the adaptor rail and configured to accept the fastener, and the clamping portion contains a hole configured to accept a set screw.

14. The cargo management assembly of claim 12, further comprising:
a truck bed rail lip locating wall extending in an inboard direction away from the base wall to abut the truck bed rail lip.

15. The cargo management assembly of claim 14, wherein:
the truck bed rail lip locating wall is shorter in length in an inboard direction than the adaptor rail locating wall.

16. The cargo management assembly of claim 12, wherein the clamping portion is shorter in axial extent than the base wall.

17. The cargo management assembly of claim 12, wherein:
the base wall includes two holes configured for accepting fasteners, and
the hole included in the clamping portion is located axially between the two holes included in the base wall.

18. A truck bed cargo management apparatus, comprising:
a plurality of truck bed adaptor retainers; and
a truck bed accessory comprising:
a coupling arm configured to insert into one or more of the truck bed adaptor retainers; and
a retention member to secure the accessory with respect to the retainers.

19. The apparatus of claim 18, wherein the truck bed adaptor rail further comprises:
an elongated base plate extending along a longitudinal axis and having an outboard portion and an inboard portion; and
an inboard flange extending along the longitudinal axis of the base plate and extending from the inboard portion of the base plate in a direction away from and below the base plate.

20. The apparatus of claim 18, wherein the truck bed accessory is a kayak rack, a ladder rack, a tire carrier, or a bed divider.
